(19) United States
(12) Patent Application Publication
(10) Pub. No.: US 2003/0177854 A1
(43) Pub. Date: Sep. 25, 2003

(54) Transmission drive unit

(76) Inventors: Walter Haussecker, Buehlertal (DE); Marco Krauth, Sinzheim (DE)

Correspondence Address: Striker Striker & Stenby, 103 East Neck Road, Huntington, NY, 11743, US

(21) Appl. No.: 10/221,297

(22) PCT Filed: Dec. 14, 2001
(86) PCT No.: PCT/DE01/04756

(30) Foreign Application Priority Data
Jan. 12, 2001 (DE) 101 01 521.6

(51) Int. Cl. F16H 1/16

(52) U.S. Cl. 74/425

(57) ABSTRACT

The invention relates to a transmission-drive unit (10), which has a housing (14) with an opening (26) and with a cap (34); at least two guide lugs (36) are disposed on the cap (34) and for closing the housing (14) are thrust under ribs (29) formed on the housing.

### PRIOR ART

The invention relates to a transmission-drive unit as generically defined by the preamble to the independent claim.

From German Patent Disclosure DE 197 27 118 A1, an electric drive unit has been disclosed in which a substantially cup-shaped transmission housing for receiving transmission elements is secured to a pole housing and is closable by a transmission cap. For instance, the transmission cap is secured to the transmission housing by means of snap hooks. A disadvantage is the installation space required for the detent device and the attendant increase in structural height of the drive unit. Moreover, with this closing technology, sealing from invading water presents problems.

Other possibilities for mounting transmission caps are also known, such as with screws, adhesive bonding, press-fitting, or ultrasonic welding. The safest and most economical method is ultrasonic welding. Although this mounting technique requires little installation space, nevertheless it fails when a transmission cap coated with an economical thermoplastic is being welded, since that sealing material cannot withstand ultrasonic welding.

### ADVANTAGES OF THE INVENTION

The device according to the invention having the characteristics of claim 1 has the advantage that even if thermoplastic sealing materials are used, a securely sealing, space-saving closure of the housing of the transmission-drive unit is assured. This is made possible because for closing the housing, guide lugs disposed on the cap are thrust under ribs that are formed onto the housing. The sealing material employed is subjected to neither ultrasound nor heat but only to mechanical stress. Because ultrasonic welding is not employed, the expense for complicated mounting machines and for their maintenance and energy requirements is saved. The transmission-drive unit of the invention makes it possible to use economical thermoplastic sealing materials, which need not be vulcanized but merely must be sprayed onto the transmission cap. Closing the housing by purely mechanically displacing the cap is an especially simple mounting technique and is thus more economical than screwing, adhesive bonding or press-fitting.

By the provisions recited in the dependent claims, advantageous refinements of the device defined by the main claim are possible. If a sealing face is formed onto the circumference of the housing opening, then pressing the cap on via the ribs and the guide lugs creates a well-defined, secure seal. An especially advantageous feature is that the variation in the height of the transmission-drive unit is minimized, since the ribs and guide lugs can be manufactured relatively precisely, and the displacement of the cap upon closure does not change the total height of the housing. This is important when the transmission-drive unit is installed where space is tight, as in the case of vehicle doors or sunroofs.

If the sealing face of the housing or the inside surface of the cap is coated with a rubberlike material, then pressing the cap against this rubberlike layer achieves an especially uniform, secure sealing action. For the adhesion of the rubberlike material, it is favorable if the entire inside surface of the cap is coated. Moreover, the rubberlike coating can then also seal off an opening in the middle of the cap from the slaving element of the transmission-drive unit. For the coating, the device of the invention allows both a vulcanizing method and spray-coating with rubberlike materials.

Spray-coating with a rubberlike material, such as a thermoplastic, of the inside of the cap is especially advantageous, because this process is technologically simple and can be managed economically. Such a layer is not damaged upon closure of the housing, since no thermal or ultrasonic stress occurs in the purely mechanical displacement operation.

The guide lugs always center the cap with the sealing face of the housing. it] This guarantees optimal sealing action and makes very simple mounting possible.

Upon displacement of the cap relative to the housing, to achieve a pressure of the cap against the sealing face, either the guide lugs or the ribs or both are shaped in such a way that their thickness increases over their closure travel. This increase in material thickness means that the contact pressure increases with the displacement. Chamfering of the guide lugs and/or ribs is especially simply achieved by injection molding the components.

It is advantageous if the cap is fixed relative to the housing after the closure, for effectively preventing detachment of the cap, for instance when it is jarred or vibration occurs. In an especially simple, space-saving way, the cap can be fixed, for instance by means of detent lugs or the like, to the ribs or guide lugs, which snap into corresponding openings. When the housing is produced by injection molding, forming the detent lugs and the opening requires no additional method steps.

The cap can be detached, for instance for maintenance work or repair, without either the cap or the housing being destroyed thereby. This allows reuse of the housing, and if a suitable sealing material is used, reuse of the cap as well.

Especially for use as a power window drive in the door of a motor vehicle, but for other applications as well, it is especially important that the penetration of water into the housing be reliably prevented; this is assured by the uniformly high contact pressures of the cap on the sealing face.

An especially space-saving closing technique between the cap and the housing is attained by providing that the guide lugs of the cap, before the displacement, are inserted upon closure into the recesses between the ribs of the housing. This makes the cap insertable and removable perpendicular to the plane of the cap.

It is especially advantageous if the cap and the housing opening are recessed with the recesses of the guide lugs and the ribs. The guide lugs of the cap can then be thrust under the ribs of the housing in a very simple way by a rotation, on the order of a bayonet mount. This kind of bayonet closure, for the opening and closing operations, requires precisely the surface area of the housing opening only. Moreover, rotating the cap to mount it is very simple to manage in production.

It is especially advantageous for from six to sixteen guide lugs to be formed on the cap and from six to sixteen ribs with recesses between them to be formed on the housing, because as a result an especially uniform nonpositive engagement with the sealing face, extending all the way around the housing, is attained. For robot assembly of the cap, it is especially favorable if the cap has as many guide lugs as possible, because this minimizes the maximum angle of rotation of the robot and makes many mounting positions possible. On the other hand, a sufficient width of the ribs and guide lugs must be maintained, to assure the mechanical stability of the connection. For a cap having the circumference in our exemplary embodiment of a power window or sunroof drive, these advantages are attained especially well if there are twelve ribs and twelve guide lugs.

If the transmission-drive unit has a shaft on which a worm wheel and a slaving element are supported, then the slaving element can advantageously be supported axially and/or radially by a recess in the cap. A reliable force-action connection between the slaving element and the worm wheel is thus assured in a simple way.

In addition, the shaft, which is disposed perpendicular to the cap, can advantageously also be supported axially and/or radially by a recess therein.

In a preferred feature, the cap has a circular opening, through which the shaft with the slaving element supported on it protrudes. The rubberlike material formed onto the cap favorably seals off the circular opening from the slaving element. Thus a continuous layer of the rubberlike material seals off the housing, both along the encompassing sealing face of the housing and from the rotatable slaving element.

If the ratio of the length of the guide lug to the diameter of the cap is in the range between 1:50 and 5:50 and if the ratio of the length of the ribs to the inside diameter of the housing is also in this same range, then a maximum clearance opening for mounting the worm wheel is attained with an only minimal increase in the outer diameter of the housing. The ratio of 3:50 is a good compromise between a maximum opening of the housing and adequate mechanical stability of the closure, because of the overlap of the ribs with the guide lugs.

The advantages of the small installation space required and in particular the low housing height and of the reliable seal from penetrating water along with the use of more-economical sealing materials are especially important if the transmission-drive unit is used as a power window or sunroof drive.

### DRAWING

One exemplary embodiment of a device of the invention is shown in the drawing and explained in further detail in the ensuing description.

FIG. 1 shows a plan view of a device of the invention without a cap;

FIG. 2 shows a cap for the exemplary embodiment of FIG. 1; and

FIG. 3 shows a section, taken along the line III-III, through FIG. 1 with the cap inserted.

### DESCRIPTION

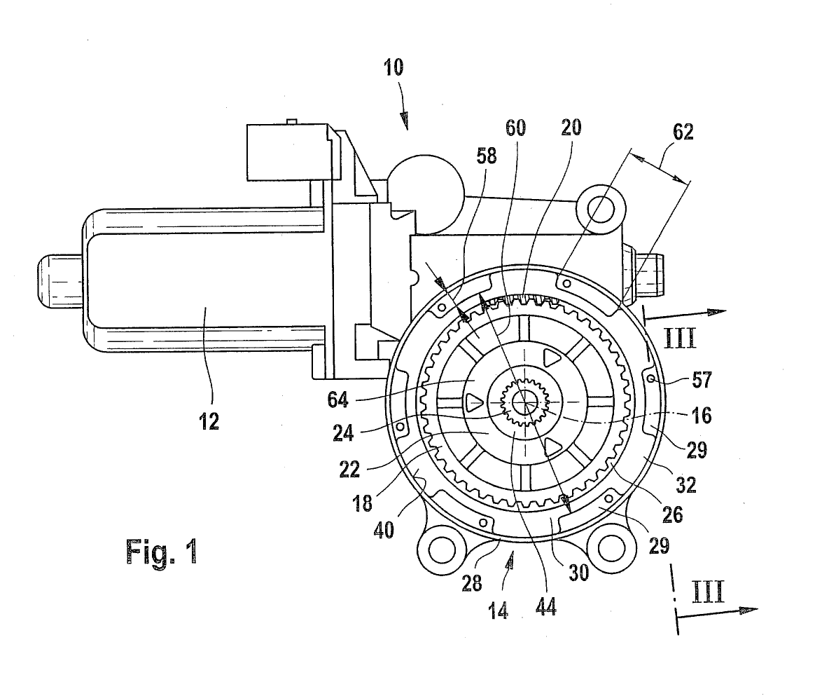

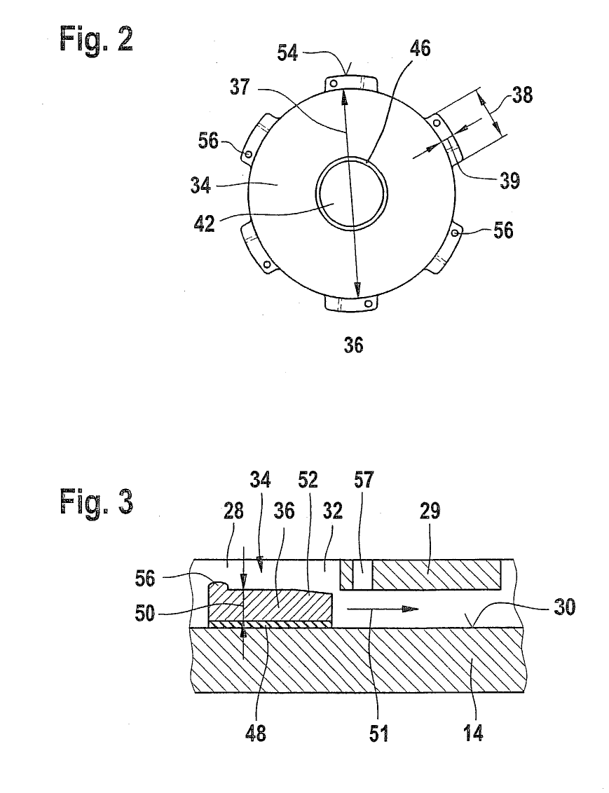

The exemplary embodiment shown in FIG. 1 shows a transmission-drive unit 10 of the invention, with a motor 12 and a transmission housing 14, into which a shaft 16 is injected in a manner fixed against relative rotation. Supported on the shaft 16 is a worm wheel 18, which is driven by a worm 20 operatively connected to the motor 12. The worm wheel 18 is engaged by a slaving element 22, also supported on the shaft 16, onto which a power takeoff pinion 24 with teeth on the outside is formed. The transmission housing 14 has a circular opening 26, through the worm wheel 18 is inserted onto the shaft 16. On the outer circumference of the housing opening 26, short ribs 29 protrude radially from a cylindrical wall 28 of the housing 14 past a sealing face 30 formed on inside the housing 14. Recesses 32 are recessed between the ribs 29, and the cap 34, shown in FIG. 2, of the transmission housing 14 is inserted into them.

The cap 34 is embodied circularly and has six guide lugs 36 on its outer circumference. The width 38 of the guide lugs 36 is dimensioned such that they fit into the recesses 32. The guide lugs 36 are of a length 39 that is precisely such that they center the cap 34 on the inside 40 of the housing wall 28. In the middle of the cap 34, a circular hole 42 is recessed, through which, when the cap 34 is inserted, the shaft 16 and one part 44 of the slaving element 22 protrude toward the free end of the shaft 16, with the power takeoff pinion 24, through the hole 42 in the cap 34. The inside of the cap 34 is spray-coated with a thermoplastic 48, as a rubberlike material 48, which also covers the insides of the guide lugs 36 and is shaped, toward the hole 42 in the cap 34, as a sealing lip 46, which seals off the housing 14 from the slaving element 22.

FIG. 3 shows a section through the transmission housing 14 with the cap 34 inserted. Once the cap 34 is introduced along the shaft 16, the rubberlike material 48 is located on the sealing face 30 of the housing 14. When the cap 34 is rotated in the direction of the arrow 51, the guide lugs 36 are thrust under the ribs 29. The material thickness 50 of the guide lug 36 is equivalent to its thickness 50, and on the side 52 toward the direction of rotation 51 upon closure, the material thickness is less than on the other side of the guide lug 36. As a result, at the onset of rotation in the closing direction 51, the guide lug 36 fits securely under the rib 29. In the course of the further rotation in the closing direction 51, the material thickness 50 of the guide lug 36 increases and as a result exerts an increasing contact pressure of the cap 34 against the sealing face 30. Upon rotation, the cap 34 is guided and centered by the guide lugs 36, and its outside 54 slides on the inside 40 of the housing wall 28. For fixing the cap 34 relative to the housing 14, the guide lugs 36 have a detent lug 56, which after the complete closure snaps into a corresponding opening 57 in the ribs 29. In principle, the detent lugs 56 could also be formed on the ribs 29, while the holes 57 could be formed on the guide lugs 36. The concrete design of the detent lugs 56 and holes 57 can also vary. In the exemplary embodiment, the ratio of the length 39 of the guide lugs 36 to the diameter 37 of the cap 34 is approximately 3:50. Because of this relatively slight overlap of the guide lugs 36 and the ribs 29, the sealing face 30 can be made relatively narrow, which makes a large opening 26 for mounting the worm wheel 18 possible without substantially increasing the structural size of the housing 14. For an adequately large opening 26, a ratio in the range from 1:50 to 5:50 of the guide lug 36 to the diameter 37 and of the rib length 58 to the diameter 60 of the housing opening 26 is possible, to assure an adequate compromise between a small structural size of the housing 14 and adequate mechanical stability of the bayonet closure. In the closed state of the housing 14, the guide lugs 36 overlap the ribs 29 over their retire respective lengths 39, 58. In this version, the cap 34 can be opened again by rotation in the opposite direction, without damaging the cap 34 or the housing 14. Thus both the housing 14 and the cap 34 can be reused after being opened, and the housing 14 can be securely sealed off from water over the course of multiple opening and closing operations.

In the closed state, the cap 34 presses against the outer region 64 of the slaving element 22, pressing it axially in the direction of the housing interior. This represents a very simple but very effective axial support of the slaving element 22, which is thereby kept operatively connected to the worm wheel 18. In a variation of the exemplary embodiment, the free end of the shaft 16, with the part 44 of the slaving element 22 and with the sealing lip 46, is additionally-radially supported in the hole 42 of the cap 34.

In a further exemplary embodiment, the cap 34 does not have any hole 42 in the middle; instead, on its inside, it has a recess for radially and axially supporting the free end of the shaft 16. Thus when the housing is closed, the cap 34 forms a second bearing for the shaft 16. In this case the rubberlike material 48 is formed directly onto the sealing face 30, and the cap 34 does not have any coating with a rubberlike material 48.

In other variations of the exemplary embodiment, the material thickness 50 of the guide lugs 36 does not vary, but the material thickness of the ribs 29 does vary over their width 62. A symmetrical arrangement of guide lugs is desirable in principle, for the sake of uniform force distribution and the advantages in terms of assembly. However, if for structural reasons this is not possible (for instance, because retaining elements are attached at one point), then a rib can also be disposed asymmetrically at at least one point. It is equally possible for an arbitrary sealing material that meets the requirements in terms of tightness off the transmission-drive unit 10 to be used as the rubberlike material 48. It does not matter whether the sealing material 48 is sprayed on or vulcanized, or whether the entire area of the cap is coated, or only parts of it. Thus it is possible for instance to coat only the cap 34, but not the guide lugs 36, with a rubberlike material 48. Also, the fixation of the cap 34 relative to the housing 14 is in no way limited to detent lugs 56 and openings 57; instead, still other means for fixation, such as dies, dowels, or the like can be imagined. The transmission-drive unit 10 of the invention is especially well suited as a drive for power windows and sunroofs, but it can also be used for other adjusting drive mechanisms inside and outside the motor vehicle and other drive mechanisms.

1. A transmission-drive unit (10), which has a housing (14) with an opening (26) and with a cap (34), characterized in that disposed on the cap (34) are at least two guide lugs (36), which for closing the housing (14) are thrust under ribs (29) formed on the housing.

2. The transmission-drive unit (10) of claim 1, characterized in that formed onto the housing (14) is a sealing face (30), against which the cap (34) is pressed via the ribs (29) and the guide lugs (36).

3. The transmission-drive unit (10) of one of claims 1 or 2, characterized in that the sealing face (30) on the housing (14) and/or the cap (34) on its inside is coated, at least in the outer circumferential region, with a rubberlike material (48).

4. The transmission-drive unit (10) of one of claims 1-3, characterized in that the cap (34) on its inside, at least in the outer circumferential region, is spray-coated with a rubberlike material (48), in particular a thermoplastic (48).

5. The transmission-drive unit (10) of one of claims 1-4, characterized in that the guide lugs (36) center the cap (34) relative to the sealing face (30) of the housing (14).

6. The transmission-drive unit (10) of one of claims 1-5, characterized in that the material thickness (50) of the guide lugs (36) and/or of the ribs (29) varies over their width (38, 62).

7. The transmission-drive unit (10) of one of claims 1-6, characterized in that the cap (34), after the closure, is fixed relative to the housing (14), in particular by means of detent lugs (56) or the like.

8. The transmission-drive unit (10) of one of claims 1-7, characterized in that the cap (34), after the closure, can be detached again without being destroyed, and at least the housing (14) is reusable.

9. The transmission-drive unit (10) of one of claims 1-8, characterized in that the cap (34) closes the housing (14) in watertight fashion.

10. The transmission-drive unit (10) of one of claims 1-9, characterized in that the housing (14), between the ribs (29), has recesses (32) into which the cap (34) can be inserted by the guide lugs (36) before the displacement.

11. The transmission-drive unit (10) of one of claims 1-10, characterized in that the cap (34) and the opening (26) are approximately circular, and the guide lugs (36) can be thrust under the ribs (29) by means of a rotation, in order to close the housing (14).

12. The transmission-drive unit (10) of claim 11, characterized in that the housing (14) has from 6 to 16 and in particular 12 ribs (29), and the cap (34) has from 6 to 16 and in particular 12 guide lugs (36).

13. The transmission-drive unit (10) of one of claims 1-12, characterized in that disposed perpendicular to the cap (34) is a shaft (16), on which a worm wheel (18) and a slaving element (22) are disposed, which are supported axially and/or radially by means of the cap (34).

14. The transmission-drive unit (10) of one of claims 1-13, characterized in that the shaft (16) is supported axially and/or radially by means of the cap (34).

15. The transmission-drive unit (10) of one of claims 1-14, characterized in that the cap (34) has a circular hole (42), which is sealed off from the slaving element (22) by means of the rubberlike material (48).

16. The transmission-drive unit (10) of one of claims 11-15, characterized in that the ratio of the length (39) of the guide lug (36) to the diameter (37) of the cap (34), and the ratio of the length (59) of the ribs (29) to the diameter (60) of the housing opening (26), are between 1:50 and 5:50, in particular approximately 3:50.

17. The transmission-drive unit (10) of one of claims 1-16, characterized in that the transmission-drive unit (10) is a power window or sunroof drive (10).
